(19) United States
(12) Patent Application Publication
(10) Pub. No.: US 2026/0106654 A1
(43) Pub. Date: Apr. 16, 2026

(54) METHOD FOR PERFORMING CHANNEL STATE INFORMATION PREPARATION WITH NON-CONNECTED DEVICE IN WIRELESS COMMUNICATION SYSTEM, AND ASSOCIATED APPARATUS

(71) Applicant: MEDIATEK INC., Hsinchu City (TW)

(72) Inventors: Chien-Chih Chen, Hsinchu City (TW); Shun-Yong Huang, Hsinchu City (TW)

(73) Assignee: MEDIATEK INC., Hsinchu City (TW)

(21) Appl. No.: 18/912,625

(22) Filed: Oct. 11, 2024

(51) Int. Cl. H04B 7/06; H04L 5/00; H04W 74/0816

(52) U.S. Cl. CPC H04B 7/0626; H04L 5/0053; H04W 74/0816

(57) ABSTRACT

A method for performing channel state information (CSI) preparation with a non-connected device in a wireless communication system and associated apparatus are provided, where a wireless transceiver device and another device acting as the non-connected device are not wirelessly linking to each other in the wireless communication system. The method may include: sending a first communication frame from the wireless transceiver device in a situation where the wireless transceiver device and the other device are not wirelessly linking to each other; and receiving a second communication frame from the other device, the second communication frame corresponding to a same bandwidth as that of the first communication frame, to acquire CSI corresponding to a predetermined subcarrier number according to the second communication frame.

### BACKGROUND

The present invention is related to communication control, and more particularly, to a method for performing channel state information (CSI) preparation with a non-connected device in a wireless communication system, and associated apparatus such as a wireless transceiver device in the wireless communication system.

According to the related art, CSI may be used for describing how a signal propagates from a transmitter to a receiver and/or representing the channel situation in wireless communication. For example, it may be suggested to adopt CSI for various detection applications such as human motion detection, proximity detection, heart rate detection, respiratory rate detection, etc., and a sufficient CSI sample rate and a sufficient detection bandwidth may be required for achieving better results of the detection applications. Some problems may occur, however. When a first device sends a data frame with a target bandwidth to a second device to acquire sufficient CSI, the first device and the second device should have been wirelessly linking to each other since the data frame traffic may only exist in such state thereof (or “the connected state”). The mechanism described above does not work in a situation where the first device and the second device are not wirelessly linking to each other. As no CSI is obtained, the first device may be forced to stop providing the associated services regarding the CSI-based detection applications. It seems that there is no proper suggestion in the related art. Thus, a novel method and associated architecture are needed for solving the problems without introducing any side effect or in a way that is less likely to introduce a side effect.

### SUMMARY

It is an objective of the present invention to provide a method for performing CSI preparation with a non-connected device in a wireless communication system, and associated apparatus such as a wireless transceiver device (e.g., an access point (AP) device and a non-AP station (STA) device) in the wireless communication system, in order to solve the above-mentioned problems.

At least one embodiment of the present invention provides a method for performing CSI preparation with a non-connected device in a wireless communication system, where a wireless transceiver device and another device acting as the non-connected device are not wirelessly linking to each other in the wireless communication system. For example, the method may comprise: sending a first communication frame from the wireless transceiver device in a situation where the wireless transceiver device and the other device are not wirelessly linking to each other; and receiving a second communication frame from the other device, the second communication frame corresponding to a same bandwidth as that of the first communication frame, to acquire CSI corresponding to a predetermined subcarrier number according to the second communication frame.

At least one embodiment of the present invention provides a wireless transceiver device, for performing CSI preparation with a non-connected device in a wireless communication system, where the wireless transceiver device is one of multiple devices within the wireless communication system such as that mentioned above. The wireless transceiver device may comprise a processing circuit that is arranged to control operations of the wireless transceiver device. The wireless transceiver device may further comprise at least one communication control circuit that is coupled to the processing circuit and arranged to perform communication control, wherein the aforementioned at least one communication control circuit is arranged to perform wireless communication operations with at least another device among the multiple devices for the wireless transceiver device. In addition, the wireless transceiver device and the other device acting as the non-connected device are not wirelessly linking to each other in the wireless communication system. For example, the wireless transceiver device is arranged to send a first communication frame from the wireless transceiver device in a situation where the wireless transceiver device and the other device are not wirelessly linking to each other; and the wireless transceiver device is arranged to receive a second communication frame from the other device, the second communication frame corresponding to a same bandwidth as that of the first communication frame, to acquire CSI corresponding to a predetermined subcarrier number according to the second communication frame.

It is an advantage of the present invention that, through proper design, the method of the present invention, as well as the associated apparatus such as the wireless transceiver device, can maintain the associated services regarding the CSI-based detection applications in various situations, and more particularly, can prepare the CSI in a situation where the wireless transceiver device and the other device are not wirelessly linking to each other since the first communication frame may exist in such state thereof (or “the non-connected state”). As a result, the overall performance can be enhanced. In addition, the method of the present invention and the associated apparatus such as the wireless transceiver device can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2, in the lower half part thereof, illustrates a non-data-frame-based control scheme of a method for performing CSI preparation with a non-connected device in a wireless communication system according to an embodiment of the present invention, where a data-frame-based control scheme leading to an out-of-service problem in the non-connected state may be illustrated in the upper half part of FIG. 2 for better comprehension.

FIG. 3 illustrates a control-frame-based control scheme of the method according to an embodiment of the present invention.

FIG. 4 illustrates a management-frame-based control scheme of the method according to an embodiment of the present invention.

FIG. 5 illustrates a CSI acquirement control scheme of the method according to an embodiment of the present invention.

FIG. 6 illustrates a CSI generation control scheme of the method according to an embodiment of the present invention.

FIG. 7 illustrates a CSI model involved with the method according to an embodiment of the present invention.

FIG. 8 illustrates a working flow of the method according to an embodiment of the present invention.

### DETAILED DESCRIPTION

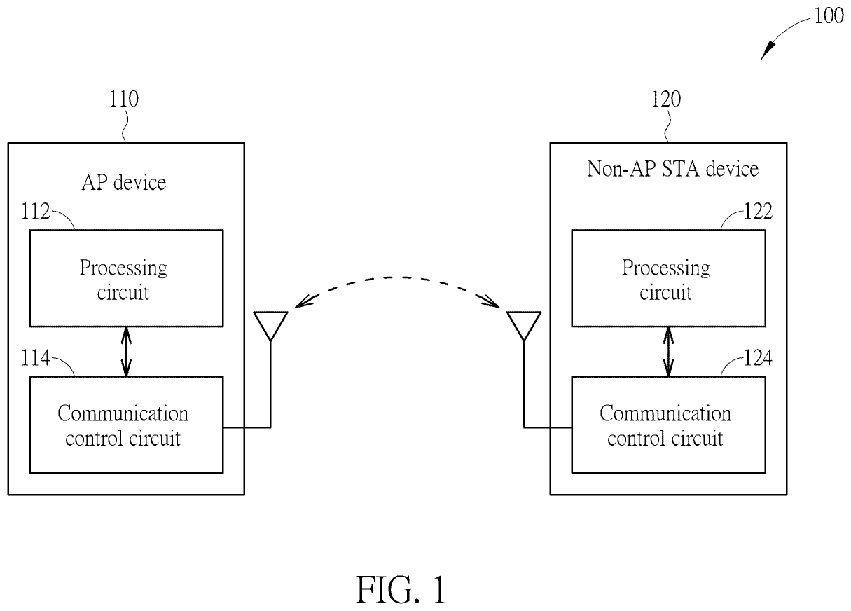

FIG. 1 is a diagram of a wireless communication system 100 according to an embodiment of the present invention. For better comprehension, the wireless communication system 100, as well as any wireless transceiver device #k among multiple wireless transceiver devices #1, . . . and #K therein, may be compatible or backward-compatible to one or more versions of the Institute of Electrical and Electronics Engineers (IEEE) 802.11 standards, but the present invention is not limited thereto. Among the multiple wireless transceiver devices #1, . . . and #K within the wireless communication system 100, a wireless transceiver device may be implemented as an AP device 110, and another wireless transceiver device may be implemented as a non-AP STA device 120, but the present invention is not limited thereto. For example, two or more wireless transceiver devices among the multiple wireless transceiver devices #1, . . . and #K may be implemented as multiple AP devices {110}. In another example, two or more wireless transceiver devices among the multiple wireless transceiver devices #1, . . . and #K may be implemented as multiple non-AP STA devices {120}. In some examples, two or more wireless transceiver devices among the multiple wireless transceiver devices #1, . . . and #K may be implemented as multiple AP devices {110}, and two or more other wireless transceiver devices among the multiple wireless transceiver devices #1, . . . and #K may be implemented as multiple non-AP STA devices {120}.

As shown in FIG. 1, the AP device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the non-AP STA device 120 may comprise a processing circuit 122, at least one communication control circuit (e.g., one or more communication control circuits), which may be collectively referred to as the communication control circuit 124, and at least one antenna (e.g., one or more antennas) of the communication control circuit 124. In the architecture shown in FIG. 1, the processing circuit 112 can be arranged to control operations of the AP device 110, and the communication control circuit 114 can be arranged to perform communication control, and more particularly, perform wireless communication operations with the network (or at least one other device therein such as the non-AP STA device 120) for the AP device 110. In addition, the processing circuit 122 can be arranged to control operations of the non-AP STA device 120, and the communication control circuit 124 can be arranged to perform communication control, and more particularly, perform wireless communication operations with the network (or at least one other device therein such as the AP device 110) for the non-AP STA device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the non-AP STA device 120 may include, but are not limited to: a multifunctional mobile phone, a laptop computer, an all-in-one computer and a wearable device.

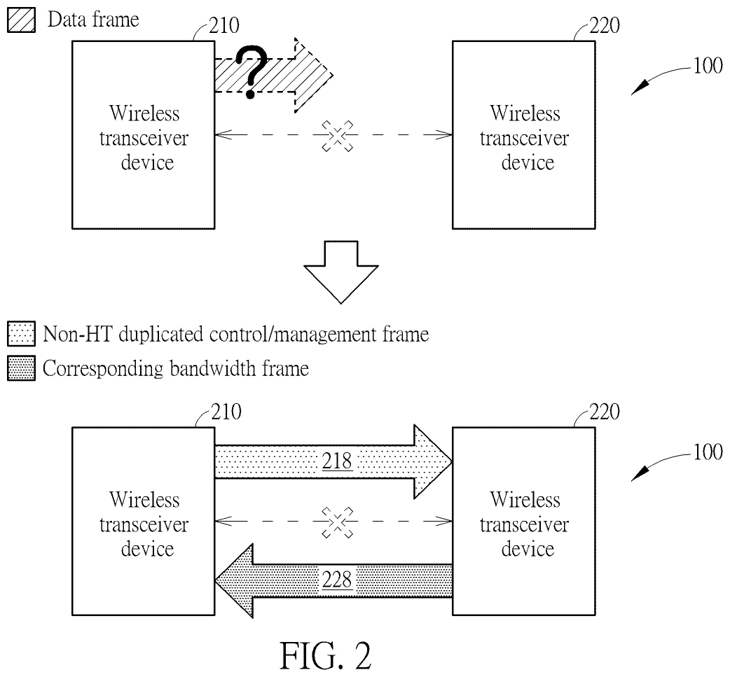

FIG. 2, in the lower half part thereof, illustrates a non-data-frame-based control scheme of a method for performing CSI preparation with a non-connected device in a wireless communication system (e.g., the wireless communication system 100) according to an embodiment of the present invention, where a data-frame-based control scheme leading to an out-of-service problem in the non-connected state may be illustrated in the upper half part of FIG. 2 for better comprehension. Assume that one or more functions of the wireless communication system 100 may be temporarily disabled to allow two wireless transceiver devices 210 and 220 among the wireless transceiver devices #1, . . . and #K therein to operate according to the data-frame-based control scheme shown in the upper half part of FIG. 2, but the present invention is not limited thereto. Based on the data-frame-based control scheme, when the wireless transceiver device 210 sends a data frame with a target bandwidth to the wireless transceiver device 210 in order to acquire sufficient CSI, the wireless transceiver devices 210 and 220 should have been wirelessly linking to each other since the data frame traffic may only exist in the connected state. In a situation where the wireless transceiver devices 210 and 220 are not wirelessly linking to each other (labeled “X” depicted with dashed lines for brevity), the wireless transceiver device 210 cannot send any data frame to the wireless transceiver device 210 (labeled “?” for brevity). As no CSI is obtained, the wireless transceiver devices 210 may be forced to stop providing the associated services regarding the CSI-based detection applications.

As shown in the lower half part of FIG. 2, the wireless communication system 100 (or the wireless transceiver devices 210 and 220 therein) may operate according to the non-data-frame-based control scheme for preparing the CSI with the aid of the non-connected device in order to achieve a better overall performance, and the associated operations may comprise:
(1) the wireless transceiver device 210 may send a first communication frame 218 from the wireless transceiver device 210, such as the first communication frame 218 capable of triggering the other device (or the wireless transceiver device 220) to reply with a second communication frame 228, in a situation where the wireless transceiver device 210 and the wireless transceiver device 220 (e.g., the wireless transceiver device 220 acting as the non-connected device) are not wirelessly linking to each other (labeled “X” depicted with dashed lines for brevity); and
(2) the wireless transceiver device 210 may receive the second communication frame 228 from the wireless transceiver device 220, such as the second communication frame 228 corresponding to the same bandwidth as that of the first communication frame 218, to acquire the CSI corresponding to a predetermined subcarrier number according to the second communication frame 228;
where the first communication frame 218 is not any data frame which may only exist in another situation where the wireless transceiver device 210 and the other device (or the wireless transceiver device 220) are wirelessly linking to each other. In addition, the first communication frame 218 may comprise a set of first subframes corresponding to a set of 20 megahertz (MHz) bandwidths, with any first subframe thereof corresponding to a 20 MHz bandwidth among the set of 20 MHz bandwidths. Additionally, the second communication frame 228 may comprise a set of second subframes corresponding to the set of 20 MHz bandwidths, with any second subframe thereof corresponding to the 20 MHz bandwidth among the set of 20 MHz bandwidths, and therefore may be regarded as a corresponding bandwidth frame that corresponds to the first communication frame 218. Examples of the two wireless transceiver devices 210 and 220 may include, but are not limited to: the AP device 110 and the non-AP STA device 120, the non-AP STA device 120 and the AP device 110, two AP devices {110}, and two non-AP STA devices {120}.

The wireless transceiver device 210 may have known the medium access control (MAC) address of the wireless transceiver device 220, for example, via a canning operation, and may send the first communication frame 218 (e.g., the first communication frame 218 carrying the MAC address of the wireless transceiver device 220) in an unicast manner. The first communication frame 218 may be implemented with a control or management frame (or “the control/management frame”) for triggering the wireless transceiver device 220 acting as the non-connected device to transmit the second communication frame 228, and the second communication frame 228 may be implemented with a control or management frame response (or “the control/management frame response”), where the control or management frame may be a control frame or a management frame. More particularly, the first communication frame 218 may be implemented with a non-high-throughput (non-HT) duplicated control or management frame (or “the non-HT duplicated control/management frame”) for triggering the wireless transceiver device 220 to transmit the second communication frame 228 corresponding to the same bandwidth as that of the first communication frame 218 in order to prepare sufficient CSI corresponding to the predetermined subcarrier number, and the second communication frame 228 may be implemented with a non-HT duplicated control or management frame response (or “the non-HT duplicated control/management frame response”), where the non-HT duplicated control or management frame may be a non-HT duplicated control frame or a non-HT duplicated management frame. When the non-HT duplicated control/management frame represents the non-HT duplicated control frame, the non-HT duplicated control/management frame response may represent the non-HT duplicated control frame response. When the non-HT duplicated control/management frame represents the non-HT duplicated management frame, the non-HT duplicated control/management frame response may represent the non-HT duplicated management frame response.

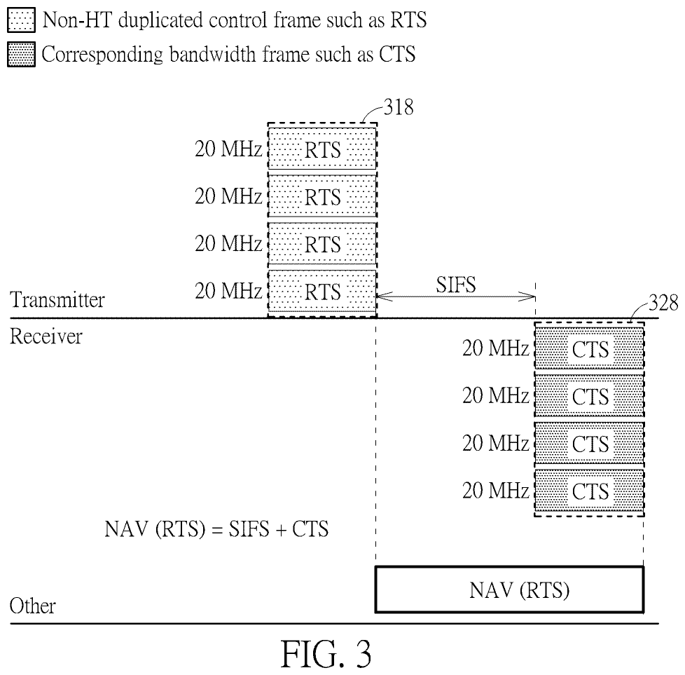

FIG. 3 illustrates a control-frame-based control scheme of the method according to an embodiment of the present invention. The first communication frame 218 and the second communication frame 228 mentioned above may be implemented with the non-HT duplicated control frame 318 and the non-HT duplicated control frame response 328 (or “the corresponding bandwidth frame 328”), respectively, where the wireless transceiver device 210 and the wireless transceiver device 220 may be labeled as “Transmitter” and “Receiver” in the timing chart shown in FIG. 3, respectively, for indicating that they are the transmitter and the receiver of the non-HT duplicated control frame 318, respectively. In addition, the non-HT duplicated control frame 318 may comprise the set of first subframes respectively corresponding to the set of 20 MHz bandwidths, and the non-HT duplicated control frame response 328 may comprise the set of second subframes respectively corresponding to the set of 20 MHz bandwidths. For example, the set of first subframes in the non-HT duplicated control frame 318 may represent a set of Request To Send (RTS) frames, and the set of second subframes in the non-HT duplicated control frame response 328 may represent a set of Clear To Send (CTS) frames.

Regarding the non-HT duplicated control frame 318 from the transmitter such as the wireless transceiver device 210 to the receiver such as the wireless transceiver device 220, the wireless transceiver device 210 may set the duration carried by a duration field of each RTS frame among the set of RTS frames within the non-HT duplicated control frame 318 to be a first target duration which is equal to one short inter-frame space (SIFS) (or the SIFS time) plus the estimated time required for transmitting one CTS frame (e.g., any CTS frame among the set of CTS frames in the non-HT duplicated control frame response 328), and all other devices such as other STAs (labeled “Other” for brevity) that can hear the RTS frame should set their network allocation vector (NAV) to be equal to the duration (e.g., the first target duration) carried by the duration field of the RTS frame and wait for this duration without performing any transmission (labeled “NAV (RTS)=SIFS+CTS” for better comprehension). As a result, the wireless transceiver device 210 may receive the non-HT duplicated control frame response 328 from the wireless transceiver device 220 successfully under the protection of the NAV corresponding to the RTS frame, in order to acquire the CSI corresponding to the predetermined subcarrier number according to the non-HT duplicated control frame response 328. For brevity, similar descriptions for this embodiment are not repeated in detail here.

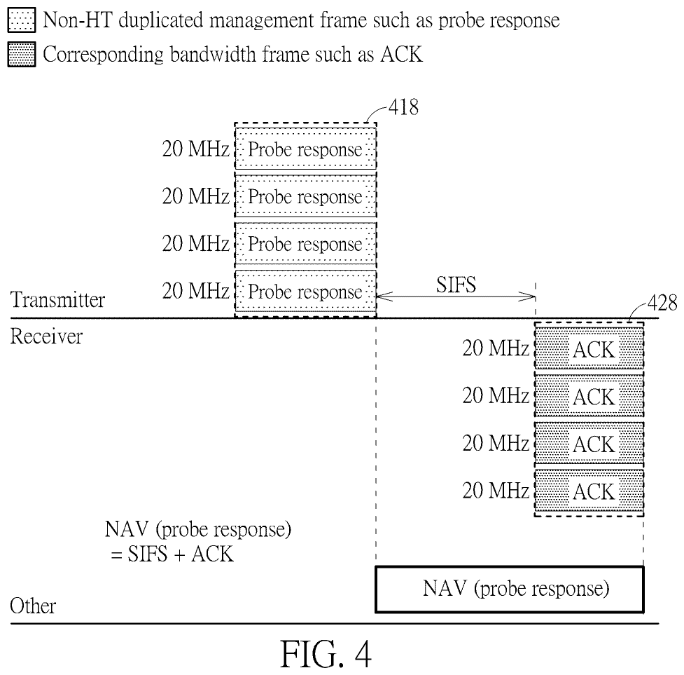

FIG. 4 illustrates a management-frame-based control scheme of the method according to an embodiment of the present invention. The first communication frame 218 and the second communication frame 228 mentioned above may be implemented with the non-HT duplicated management frame 418 and the non-HT duplicated management frame response 428 (or “the corresponding bandwidth frame 428”), respectively, where the wireless transceiver device 210 and the wireless transceiver device 220 may be labeled as “Transmitter” and “Receiver” in the timing chart shown in FIG. 4, respectively, for indicating that they are the transmitter and the receiver of the non-HT duplicated management frame 418, respectively. In addition, the non-HT duplicated management frame 418 may comprise the set of first subframes respectively corresponding to the set of 20 MHz bandwidths, and the non-HT duplicated management frame response 428 may comprise the set of second subframes respectively corresponding to the set of 20 MHz bandwidths. For example, the set of first subframes in the non-HT duplicated management frame 418 may represent a set of probe response frames, and the set of second subframes in the non-HT duplicated management frame response 428 may represent a set of acknowledgment (ACK) frames.

Regarding the non-HT duplicated management frame 418 from the transmitter such as the wireless transceiver device 210 to the receiver such as the wireless transceiver device 220, the wireless transceiver device 210 may set the duration carried by a duration field of each probe response frame among the set of probe response frames within the non-HT duplicated management frame 418 to be a second target duration which is equal to one SIFS (or the SIFS time) plus the estimated time required for transmitting one ACK frame (e.g., any ACK frame among the set of ACK frames in the non-HT duplicated management frame response 428), and all other devices such as other STAs (labeled “Other” for brevity) that can hear the probe response frame should set their NAV to be equal to the duration (e.g., the second target duration) carried by the duration field of the probe response frame and wait for this duration without performing any transmission (labeled “NAV (probe response)=SIFS+ACK” for better comprehension). As a result, the wireless transceiver device 210 may receive the non-HT duplicated management frame response 428 from the wireless transceiver device 220 successfully under the protection of the NAV corresponding to the probe response frame, in order to acquire the CSI corresponding to the predetermined subcarrier number according to the non-HT duplicated management frame response 428. For brevity, similar descriptions for this embodiment are not repeated in detail here.

According to some embodiments, when a wireless signal before the transmission thereof from the wireless transceiver device 220 is a known signal to the wireless transceiver device 210, the wireless signal may indicate the channel state after the wireless transceiver device 210 receives it. For example, before transmitting the second communication frame 228 comprising the set of second subframes, the wireless transceiver device 220 should at least carry one or more sets of predetermined bits in one or more predetermined fields within the physical layer (PHY) preamble of any second subframe among the set of second subframes (e.g., the set of CTS frames in the non-HT duplicated control frame response 328, or the set of ACK frames in the non-HT duplicated management frame response 428) respectively corresponding to the set of 20 MHz bandwidths, and therefore at least one portion (e.g., one or more portions) of the second communication frame 228, such as the PHY preambles of the set of second subframes, may be regarded as given or known signal(s) before the transmission of the second communication frame 228, where the second communication frame 228 after the transmission thereof may indicate the channel state. As a result, the wireless transceiver device 210 may generate the CSI corresponding to the predetermined subcarrier number according to the second communication frame 228 that has been received. For brevity, similar descriptions for these embodiments are not repeated in detail here.

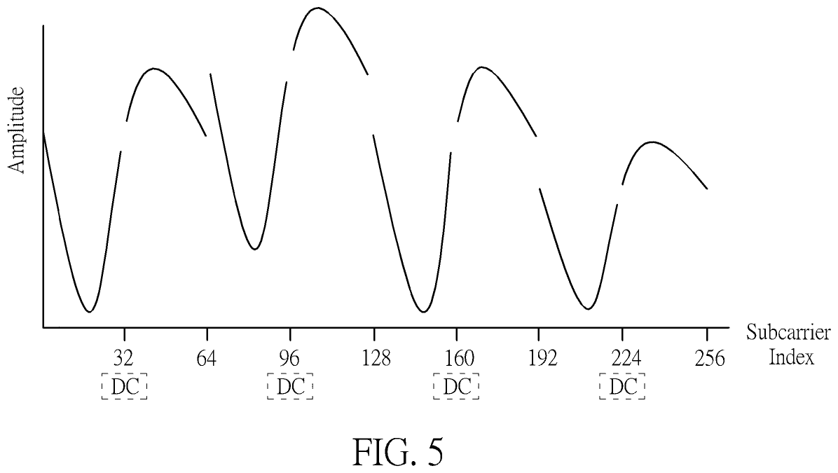

FIG. 5 illustrates a CSI acquirement control scheme of the method according to an embodiment of the present invention. The CSI corresponding to the predetermined subcarrier number may be expressed with the curves shown in FIG. 5, where the horizontal axis may represent the subcarrier index of multiple subcarriers, and the vertical axis may represent the amplitude for indicating the CSI. For example, the multiple subcarriers may comprise 256 orthogonal frequency-division multiplexing (OFDM) subcarriers (or OFDM tones) corresponding to an 80 MHz total bandwidth (or “the OFDM 80 MHz bandwidth”), with 64 subcarriers per 20 MHz channel/sub-bandwidth, but the present invention is not limited thereto. According to some embodiments, the curves shown in FIG. 5, the predetermined subcarrier number such as the number of the multiple subcarriers, the total bandwidth, and/or the number of subcarriers per 20 MHz channel/sub-bandwidth may vary.

During receiving the second communication frame 228 from the wireless transceiver device 220 to acquire the CSI corresponding to the predetermined subcarrier number according to the second communication frame 228, the wireless transceiver device 210 may receive the second communication frame 228 (e.g., the non-HT duplicated control frame response 328 corresponding to the same bandwidth as that of the non-HT duplicated control frame 318, or the non-HT duplicated management frame response 428 corresponding to the same bandwidth as that of the non-HT duplicated management frame 418) from the other device such as the wireless transceiver device 220 to acquire the CSI with respect to the subcarrier index in a range of subcarriers (or the range of the interval [1, 256] on the horizontal axis) corresponding to the predetermined subcarrier number (e.g., 256) according to the second communication frame 228. For example, when the second communication frame 228 represents the non-HT duplicated control frame response 328, the wireless transceiver device 210 may acquire the CSI with the 256 subcarriers by using the set of CTS frames of the OFDM 80 MHz bandwidth. In another example, when the second communication frame 228 represents the non-HT duplicated management frame response 428, the wireless transceiver device 210 may acquire the CSI with the 256 subcarriers by using the set of ACK frames of the OFDM 80 MHz bandwidth. Additionally, the amplitude may be equal to zero for the cases of direct-current (DC) subcarriers (labeled “DC” for brevity). More particularly, there is no amplitude on the OFDM DC subcarrier per 20 MHz bandwidth. For example, regarding the 80 MHz bandwidth occupied by the non-HT duplicated control frame response 328 or the non-HT duplicated management frame response 428, a subcarrier may be a DC subcarrier when the subcarrier index thereof is equal to any of {32, 96, 160, 224}. For brevity, similar descriptions for this embodiment are not repeated in detail here.

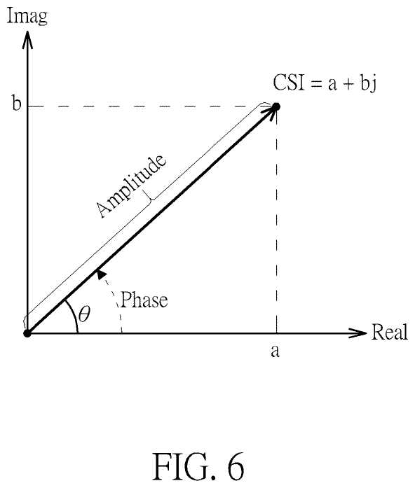

FIG. 6 illustrates a CSI generation control scheme of the method according to an embodiment of the present invention. On the complex plane of complex numbers, the horizontal axis may represent the real axis (labeled “Real” for brevity), and the vertical axis may represent the imaginary axis (labeled “Imag” for brevity), where a complex value (a+bj) on the complex plane may comprise the real part “a” and the imaginary part “b” and may be expressed with the amplitude and the phase θ thereof. For example, the CSI raw data (or the raw data of the CSI) may be complex numbers (labeled “CSI=a+bj” for brevity), and the wireless transceiver device 210 may generate or obtain the CSI raw data from the set of second subframes (e.g., the set of CTS frames in the non-HT duplicated control frame response 328, or the set of ACK frames in the non-HT duplicated management frame response 428) and calculate the respective amplitudes of the CSI raw data to generate the CSI corresponding to the predetermined subcarrier number. For brevity, similar descriptions for this embodiment are not repeated in detail here.

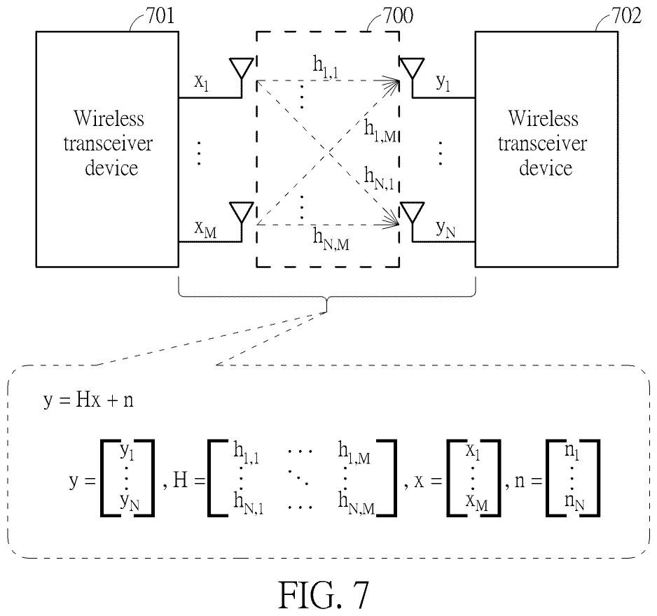

FIG. 7 illustrates a CSI model involved with the method according to an embodiment of the present invention. The CSI may be used for representing the channel state/situation. For example, the following equation Eq(1) may be used for modeling the communication system:

y=Hx+n; Eq(1)

where “y” may represent the received signal, “H” may represent the CSI, “x” may represent the transmitted signal, and “n” may represent the noise. As shown in the upper half part of FIG. 7, the CSI 700 may be arranged to describe how the signal will be transmitted from a transmitter such as the wireless transceiver device 701 to a receiver such as the wireless transceiver device 702. The wireless transceiver device 702 may perform channel estimation by the long training field (LTF) in the PHY preamble to generate a CSI matrix. Typically, the CSI may be expressed with an N×M matrix having complex values as the elements thereof, such as the matrix of H shown in the lower half part of FIG. 7, where “N” may represent the antenna number of the receiver such as the wireless transceiver device 702, and “M” may represent the antenna number of the transmitter such as the wireless transceiver device 701. For example, the received signal y may comprise N sub-signals such as the signals {y₁, . . ., y_{N}}, the transmitted signal x may comprise M sub-signals such as the signals {x₁, . . ., x_{M}}, and the noise n may comprise N noise components such as the noise components {n₁, . . ., n_{N}}. In addition, the matrix of H may comprise (N*M) elements {h} such as the elements {{h_{1,1}, . . ., h_{1,M}}, . . ., {h_{N,1}, . . ., h_{N,M} M}}, all of which are complex values. In each complex value among these complex values, the real part may be arranged to describe the amplitude variance and the imaginary part may be arranged to describe the phase variance. As the CSI may represent the channel state, and the activities in the space (or channel) may affect the channel state, it is possible to correlate the activities and the CSI. For example, the wireless transceiver device 220 may play the role of the wireless transceiver device 701 to transmit the transmitted signal x (e.g., the second communication frame 228 being transmitted), and the wireless transceiver device 210 may play the role of the wireless transceiver device 702 to receive the received signal y (e.g., the second communication frame 228 being received). Based on the characteristics of CSI, the wireless transceiver device 210 may adopt the CSI for various kinds of fancy detection applications such as human motion detection, proximity detection, heart rate detection, respiratory rate detection, etc., and more particularly, obtain sufficient CSI without being hindered by the non-connected state.

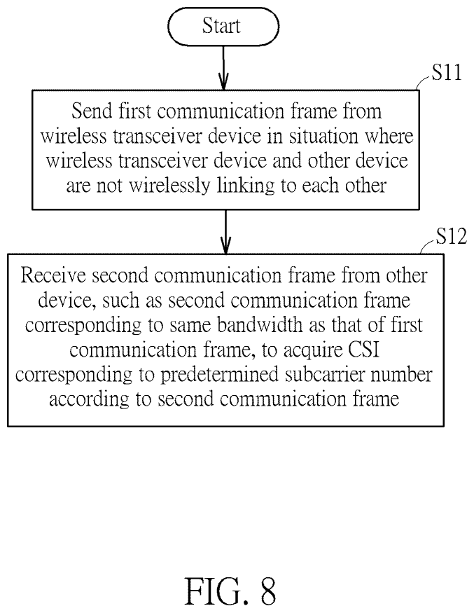

FIG. 8 illustrates a working flow of the method according to an embodiment of the present invention. The wireless transceiver device #k such as the wireless transceiver device 210 (e.g., the AP device 110 or the non-AP STA device 120) may operate according to the working flow shown in FIG. 8 in order to prepare the CSI with the aid of another device such as the wireless transceiver device 220 acting as non-connected device, but the present invention is not limited thereto.

In Step S11, the wireless transceiver device 210 may send the first communication frame 218 from the wireless transceiver device 210, such as the first communication frame 218 capable of triggering the other device (or the wireless transceiver device 220) to reply with the second communication frame 228, in the situation where the wireless transceiver device 210 and the other device such as the non-AP STA device 120 are not wirelessly linking to each other.

In Step S12, the wireless transceiver device 210 may receive the second communication frame 228 from the other device (or the non-AP STA device 120), such as the second communication frame 228 corresponding to the same bandwidth as that of the first communication frame 218, to acquire the CSI corresponding to the predetermined subcarrier number according to the second communication frame 228.

Preferably, the first communication frame 218 may be implemented with the non-HT duplicated control/management frame such as the non-HT duplicated control frame 318 or the non-HT duplicated management frame 418, and the second communication frame 228 may be implemented with the non-HT duplicated control/management frame response such as the non-HT duplicated control frame response 328 or the non-HT duplicated management frame response 428. For brevity, similar descriptions for this embodiment are not repeated in detail here.

For better comprehension, the method may be illustrated with the working flow shown in FIG. 8, but the present invention is not limited thereto. According to some embodiments, one or more steps may be added, deleted, or changed in the working flow shown in FIG. 8. For example, the wireless transceiver device 210 may send the first communication frame 218 from the wireless transceiver device 210, with the duration in the duration field of each first subframe among the set of first subframes (e.g., the set of RTS frames in the non-HT duplicated control frame 318, or the set of probe response frames in the non-HT duplicated management frame 418) being set for making one or more other devices (e.g., all other devices such as other STAs) capable of hearing the aforementioned each first subframe wait for this duration without performing any transmission until the reception of the second communication frame 228 is completed, in the situation where the wireless transceiver device 210 and the other device such as the non-AP STA device 120 are not wirelessly linking to each other. More particularly, the wireless transceiver device 210 may set the duration carried by the duration field of the aforementioned each first subframe among the set of first subframes to be a target duration (e.g., the first target duration or the second target duration) which is equal to one SIFS plus the estimated time required for transmitting any second frame among the set of second subframes (e.g., the set of CTS frames in the non-HT duplicated control frame response 328, or the set of ACK frames in the non-HT duplicated management frame response 428), rather than setting the duration to be greater than the target duration. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing channel state information (CSI) preparation with a non-connected device in a wireless communication system, wherein a wireless transceiver device and another device acting as the non-connected device are not wirelessly linking to each other in the wireless communication system, the method comprising:
sending a first communication frame from the wireless transceiver device in a situation where the wireless transceiver device and the other device are not wirelessly linking to each other; and
receiving a second communication frame from the other device, the second communication frame corresponding to a same bandwidth as that of the first communication frame, to acquire CSI corresponding to a predetermined subcarrier number according to the second communication frame.

2. The method of claim 1, wherein sending the first communication frame from the wireless transceiver device in the situation where the wireless transceiver device and the other device are not wirelessly linking to each other further comprises:
sending the first communication frame from the wireless transceiver device, the first communication frame capable of triggering the other device to reply with the second communication frame, in the situation where the wireless transceiver device and the other device are not wirelessly linking to each other.

3. The method of claim 1, wherein the first communication frame is not any data frame.

4. The method of claim 3, wherein the first communication frame is not the any data frame which only exists in another situation where the wireless transceiver device and the other device are wirelessly linking to each other.

5. The method of claim 1, wherein the first communication frame comprises a set of first subframes corresponding to a set of 20 megahertz (MHz) bandwidths, with any first subframe corresponding to a 20 MHz bandwidth among the set of 20 MHz bandwidths.

6. The method of claim 5, wherein the second communication frame comprises a set of second subframes corresponding to the set of 20 MHz bandwidths, with any second subframe corresponding to the 20 MHz bandwidth among the set of 20 MHz bandwidths.

7. The method of claim 1, wherein the first communication frame is implemented with a non-high-throughput (non-HT) duplicated control or management frame, the non-HT duplicated control or management frame being a non-HT duplicated control frame or a non-HT duplicated management frame.

8. The method of claim 1, wherein the first communication frame is implemented with a non-high-throughput (non-HT) duplicated control frame; and the non-HT duplicated control frame comprises a set of first subframes respectively corresponding to a set of 20 megahertz (MHz) bandwidths.

9. The method of claim 8, wherein the set of first subframes represent a set of request to send (RTS) frames.

10. The method of claim 8, wherein the second communication frame is implemented with a non-HT duplicated control frame response; and the non-HT duplicated control frame response comprises a set of second subframes respectively corresponding to the set of 20 MHz bandwidths.

11. The method of claim 10, wherein the set of first subframes represent a set of request to send (RTS) frames, and the set of second subframes represent a set of clear to send (CTS) frames.

12. The method of claim 1, wherein the first communication frame is implemented with a non-high-throughput (non-HT) duplicated management frame; and the non-HT duplicated management frame comprises a set of first subframes respectively corresponding to a set of 20 megahertz (MHz) bandwidths.

13. The method of claim 12, wherein the set of first subframes represent a set of probe response frames.

14. The method of claim 12, wherein the second communication frame is implemented with a non-HT duplicated management frame response; and the non-HT duplicated management frame response comprises a set of second subframes respectively corresponding to the set of 20 MHz bandwidths.

15. The method of claim 14, wherein the set of first subframes represent a set of probe response frames, and the set of second subframes represent a set of acknowledgment (ACK) frames.

16. The method of claim 1, wherein receiving the second communication frame from the other device, the second communication frame corresponding to the same bandwidth as that of the first communication frame, to acquire the CSI corresponding to the predetermined subcarrier number according to the second communication frame further comprises:
receiving the second communication frame from the other device, the second communication frame corresponding to the same bandwidth as that of the first communication frame, to acquire the CSI with respect to subcarrier index in a range of subcarriers corresponding to the predetermined subcarrier number according to the second communication frame.

17. The method of claim 1, wherein the first communication frame comprises a set of first subframes respectively corresponding to a set of 20 megahertz (MHz) bandwidths; and sending the first communication frame from the wireless transceiver device in the situation where the wireless transceiver device and the other device are not wirelessly linking to each other further comprises:
sending the first communication frame from the wireless transceiver device, with a duration in a duration field of each first subframe among the set of first subframes being set for making one or more other devices capable of hearing said each first subframe wait for the duration without performing any transmission until the reception of the second communication frame is completed, in the situation where the wireless transceiver device and the other device are not wirelessly linking to each other.

18. The method of claim 17, wherein the second communication frame comprises a set of second subframes respectively corresponding to the set of 20 MHz bandwidths; and sending the first communication frame from the wireless transceiver device in the situation where the wireless transceiver device and the other device are not wirelessly linking to each other further comprises:
setting the duration carried by the duration field of said each first subframe among the set of first subframes to be a target duration which is equal to one short inter-frame space (SIFS) plus an estimated time required for transmitting any second frame among the set of second subframes, rather than setting the duration to be greater than the target duration.

19. A wireless transceiver device, for performing channel state information (CSI) preparation with a non-connected device in a wireless communication system, the wireless transceiver device comprising:
a processing circuit, arranged to control operations of the wireless transceiver device; and
at least one communication control circuit, coupled to the processing circuit, arranged to perform communication control, wherein the at least one communication control circuit is arranged to perform wireless communication operations with at least another device within the wireless communication system for the wireless transceiver device, wherein the wireless transceiver device and the other device acting as the non-connected device are not wirelessly linking to each other in the wireless communication system;
wherein:
the wireless transceiver device is arranged to send a first communication frame from the wireless transceiver device in a situation where the wireless transceiver device and the other device are not wirelessly linking to each other; and
the wireless transceiver device is arranged to receive a second communication frame from the other device, the second communication frame corresponding to a same bandwidth as that of the first communication frame, to acquire CSI corresponding to a predetermined subcarrier number according to the second communication frame.
